(19) United States
(12) Patent Application Publication
(10) Pub. No.: US 2016/0309661 A1
(43) Pub. Date: Oct. 27, 2016

(54) Leaf Blower Having A Guard

(71) Applicant: AC (Macao Commercial Offshore) Limited, Macau (MO)

(72) Inventors: Charles A. Eakins, JR., Liberty, SC (US); Erick M. Dickman, Hartwell, GA (US)

(21) Appl. No.: 15/133,828

(22) Filed: Apr. 20, 2016

Related U.S. Application Data
(60) Provisional application No. 62/178,941, filed on Apr. 23, 2015.

(51) Int. Cl. A01G 1/12

(52) U.S. Cl. CPC A01G 1/125

(57) ABSTRACT

A blower can have a housing having an inlet, an outlet, and a volute channel in fluid communication with the inlet and the outlet. A fan assembly may be at least partially supported by the housing, and include a fan, and a driving mechanism can be coupled to the fan assembly for rotating the fan to create air flow through the housing. A tube can be removably connected to the housing and in fluid communication with the outlet to direct air flow exiting the housing, and a guard can be at least partially received within the tube. The guard can have guard features preventing access to the housing and attachment features attaching the tube to the housing.

### CROSS-REFERENCE TO RELATED APPLICATIONS

This application claims the benefit of U.S. Provisional Patent Application No. 62/178,941, filed on Apr. 23, 2015.

### INCORPORATION BY REFERENCE

The disclosure of U.S. Provisional Patent Application No. 62/178,941, which was filed on Apr. 23, 2015, is hereby incorporated by reference for all purposes as if presented herein in its entirety.

### BACKGROUND OF THE DISCLOSURE

The present disclosure generally relates to hand held power tools, such as leaf blowers. More specifically, the present disclosure relates to a leaf blower having a guard.

### SUMMARY OF THE DISCLOSURE

In general, one aspect of this disclosure is directed to a blower that can include a housing defining an inlet, an outlet, and a volute channel in fluid communication with the inlet and the outlet. The blower may also have a fan assembly at least partially supported by the housing, which includes a fan, and a driving mechanism that can be coupled to the fan assembly for rotating the fan to create air flow through the housing. A tube may be removably connected to the housing and in fluid communication with the outlet to direct air flow exiting the housing, and a guard can be at least partially received within the tube, which guard may have guard features preventing access to the housing, as well as attachment features attaching the guard to the tube.

In another aspect, this disclosure is directed to a tube assembly for connection to a blower. The tube assembly may include a tube for removable connection to a housing of the blower that directs air flow exiting the housing, and a guard that can be at least partially received within the tube and that can have guard features for preventing access to the housing and attachment features for attaching the guard to the tube.

In another aspect, this disclosure is directed to a guard for use in a blower assembly including a housing and a tube for directing air flow exiting the housing. The guard may have guard features for preventing access to the housing and attachment features for attaching the guard to the tube.

In another aspect, this disclosure is directed to a method for assembling a blower, which method includes obtaining a housing having an inlet, an outlet, an a volute channel in fluid communication with the inlet and outlet, a tube, and a guard with guard features and attachment features, the method comprises positioning the guard at least partially within the tube, attaching the guard to the tube by inserting the attachment features through an aperture in the tube, and attaching the tube to the housing.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIGS. 1A-C show various perspective views of a blower according to one embodiment of the present disclosure;

FIGS. 2A-B show partial cutaway views of a housing of the blower of FIGS. 1A-B;

FIG. 3 is a partial cutaway view of the housing of the blower of FIGS. 1A-B with a blower tube removed and showing a guard positioned within the housing;

FIG. 4 is a partial cutaway view of a blower tube assembly with the blower tube and guard connect to the housing;

FIG. 5 is an additional partial cutaway view of the blower tube assembly with the blower tube and guard connect to the housing;

FIG. 6 is an additional partial cutaway view of the housing of blower of FIGS. 1A-B with the blower tube removed and showing a guard positioned within the housing;

FIG. 7 is a perspective view of the guard according to one aspect of this disclosure;

FIG. 8 is an enlarged partial cutaway view of a portion of the guard of FIG. 7;

FIG. 9 is an enlarged partial cutaway view of another portion of the guard and blower tube;

FIGS. 10A-B show a partial cutaway view and a cross-sectional view, respectively, of the blower tube assembly, attached to the housing of the blower of FIG. 1A-B.

Corresponding parts are designated by corresponding reference numbers throughout the drawings.

### DETAILED DESCRIPTION OF THE EXEMPLARY EMBODIMENTS

The present disclosure relates to powered hand tools, and may include a system and related elements that perform the dual functions of releasably attaching one tool part to another, and also preventing foreign objects from reaching the moving parts of the tool. A leaf blower or yard blower 10 is shown to illustrate one application of the disclosure. The blower 10 may have a blower tube assembly 66 that includes a blower tube 23 attached to a housing 11 of the blower 10, and a guard 45 fitted or received within and attached to the blower tube 23. The guard 45 can include various features that prevent debris or other foreign objects from entering the housing 11, as well as one or more attachment features for attaching the guard 45 to the blower tube 23.

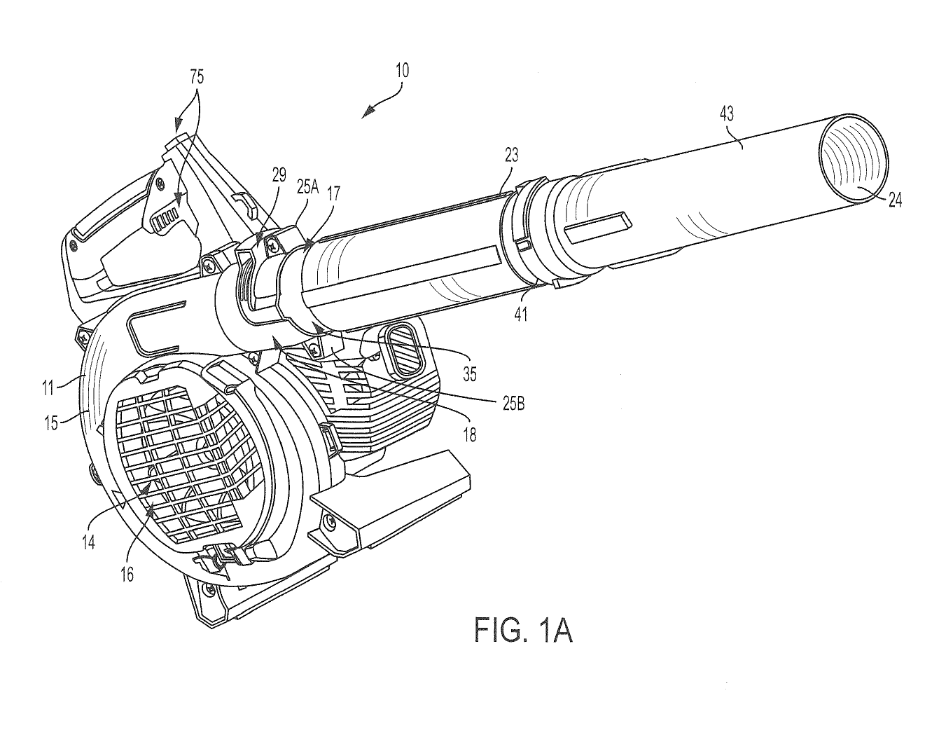

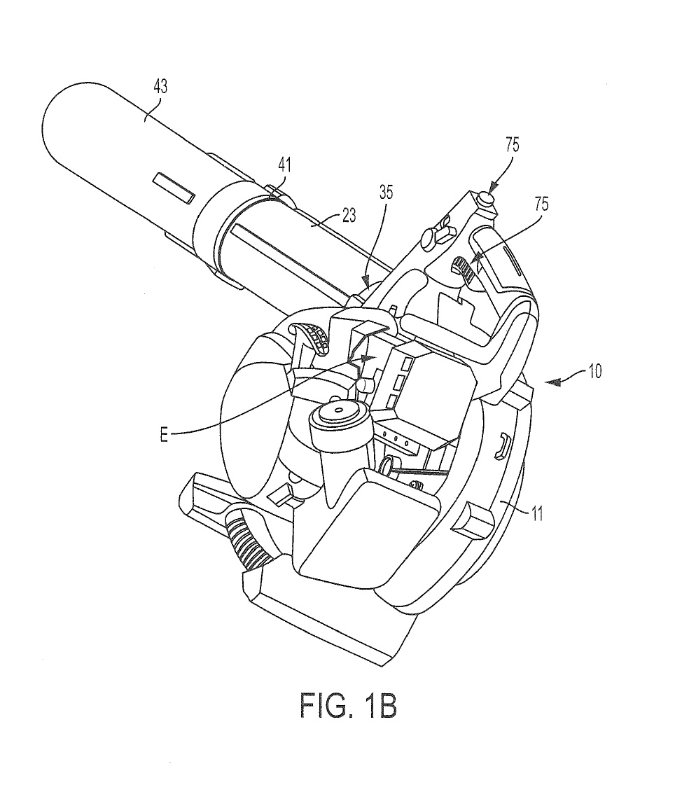

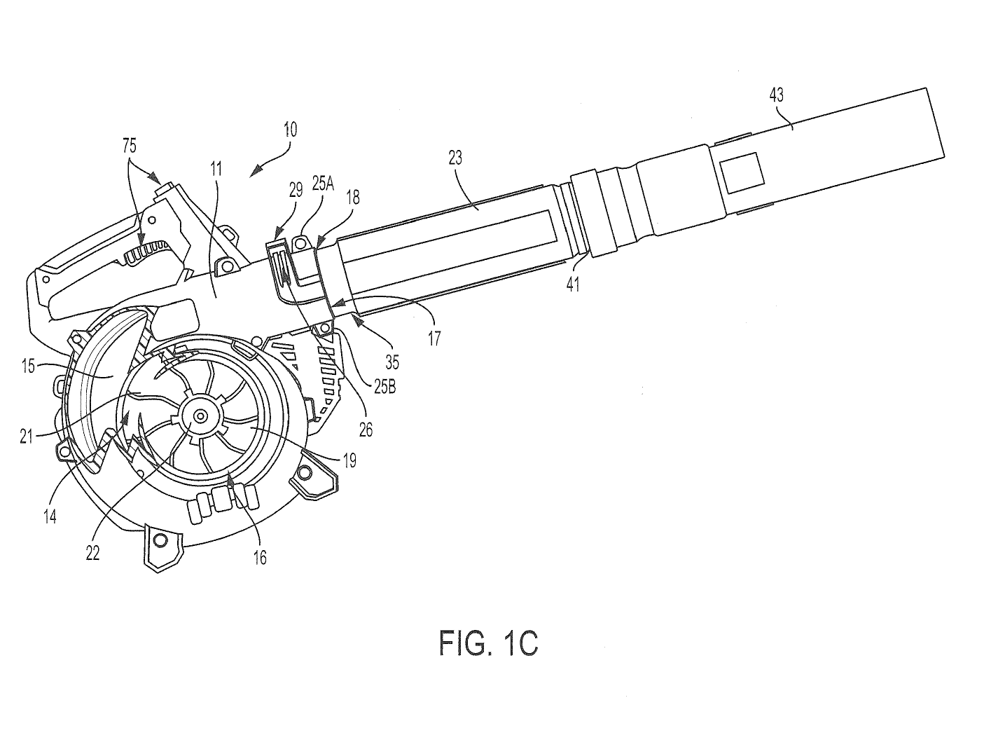

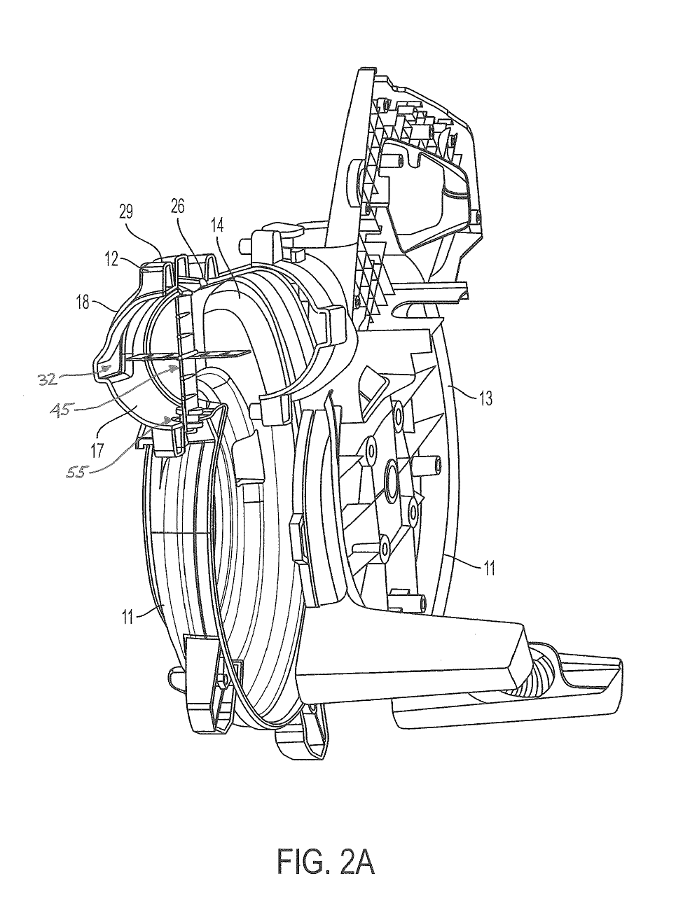

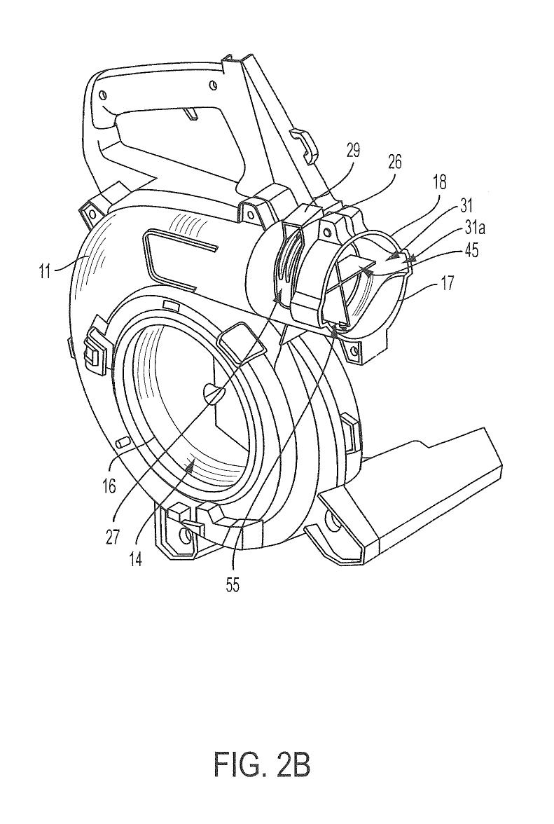

FIGS. 1A-C show various views of the leaf blower 10, including the volute shaped blower body or housing 11 usually made of molded plastic or other lightweight material that can be readily formed into the desired shapes. In one embodiment, the volute housing may include housing half portions, for example, a first half portion 12 and a second half portion 13, as generally shown in FIGS. 2A-B, which are joined with fasteners, such as screws, pins or other fastening means (not shown), to form the housing 11. The housing 11 may define an interior cavity 14, into part of which additional elements may be contained. The housing 11 also can define a curved volute channel 15 through which air is directed at a higher pressure than ambient air, to exit the housing 11 at a relatively high velocity. The housing 11 also can define an air intake aperture 16, and an air outlet aperture 17 at the distal end 18 portion of the volute channel 15. The housing 11 may support a circular fan assembly 19 including blades 21 mounted around or along a hub 22. A gasoline engine E can be mounted within the housing 11 to cause the fan 19 to rotate in a predetermined/desired direction. Alternatively, the blower 10 may comprise an electric motor without departing from the scope of this disclosure. A blower tube 23 can be attached to outlet aperture 17, and the air drawn into aperture 16 may be directed into and moved around the volute channel 15 to exit the outlet aperture 17 and then out through the blower tube 23. The blower tube 23 is shown as an elongated tube that defines a cavity 24 therein, and directs the pressurized air from the housing 11. The leaf blower 10 additionally can include control switches 75 and wiring to power the fan assembly 19 on and off, control the speed of fan rotation or control various other functions.

In one embodiment, the distal end portion 18 of the volute channel 15 includes two mounting brackets 25A and 25B, each of which defines channels therethrough (FIG. 1C). A strap (not shown) including clips can be attached to each of the mounting brackets 25A, 25B for supporting the leaf blower 10.

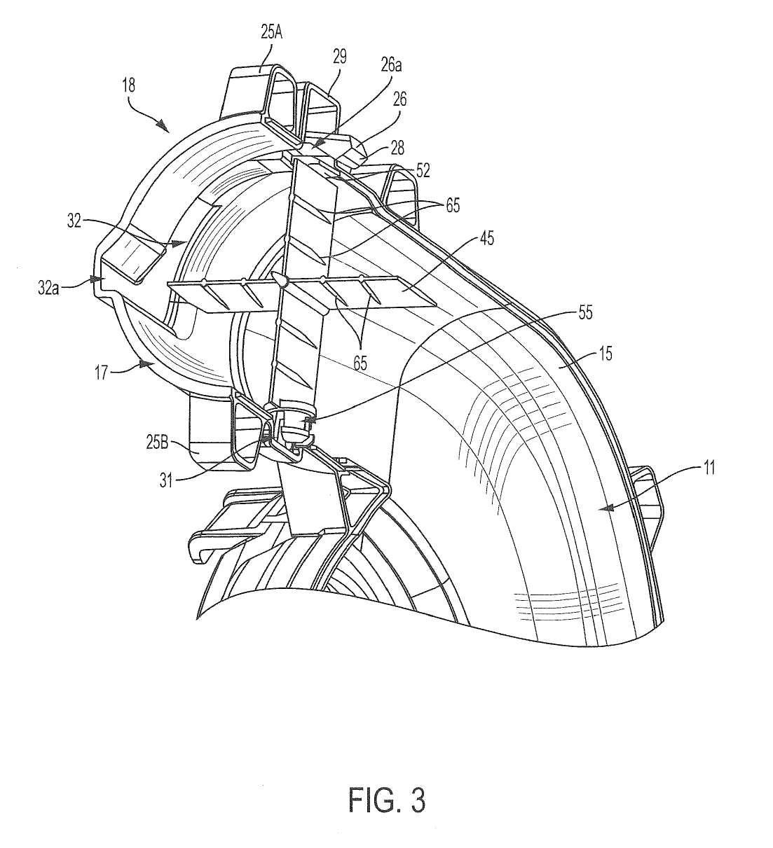

A distal end portion 18 of the volute channel 15 can be formed or configured to include various features that together perform the desired functions of releasably locking the blower tube 23 and guard 45 to the housing 11. A volute lock tab 26 can be provided along an end portion 18 of housing 11 along its upper side, although the lock tab 26 and/or other locking and guiding features of distal end 18 can be located at various desired positions at or along the distal end 18 of housing 11 without departing from this disclosure (FIGS. 2A-B). Lock tab 26 may be joined to the distal end 18 of the housing 11 at or about proximal tab end 27, and the lock tab 26 can include a free or tab distal portion 28 so that lock tab 26 can be lifted a small distance, for example approximately ⅜ inch, away from the distal end 18 and housing 11 to engage with at least a portion of the blower tube 23 as discussed below (FIGS. 3 and 5). Lock tab 26 also can be made of the plastic used in the molding of the housing 11, and may have a spring action, which allows lock tab 26 to be manually lifted at its tab distal portion 28 from housing 11, and then spring or move back toward housing 11 when released. A separate lock tab 26 made of metal or other material with such spring and latching properties could be provided without departing from the scope of this disclosure. A lock tab cover 29 can be formed along housing 11 to protect or guard the lock tab 26 from physical damage or an untended lifting of the tab distal portion 28. As can be seen in FIG. 3, tab cover 29 may be spaced apart from the lock tab 26 to protect lock tab 26 while also allowing the lock tab 26 to be lifted away from housing 11.

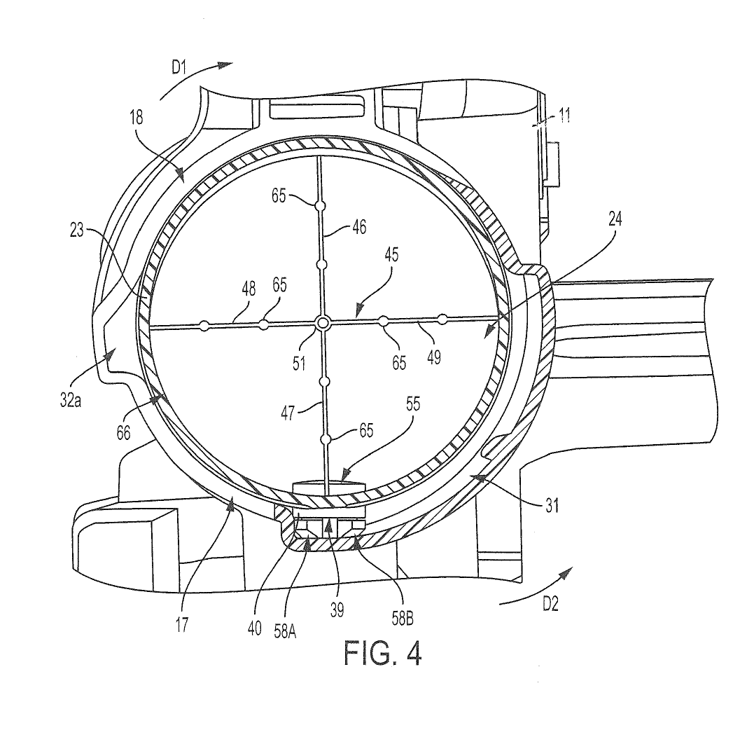

As shown in FIG. 4, the generally circular shaped distal end portion 18 also may define a volute guide slot 31, integral with housing 11. The volute guide channel or slot 31 may extend approximately ¼ of the circumference of the opening of the distal end portion 18, from a bottom or six o'clock position counterclockwise to the right side, or 3 o'clock position, in the view of FIG. 4. The distal end portion 18 also may define an anti-pivot tab slot 32 extending approximately ¼ of the circumference of the opening of the end portion 18 from approximately the top of the distal end portion 18 counterclockwise to approximately the 9 o'clock position, in the view of FIG. 5. The channels or slots 31, 32 can be formed at various other positions around distal end portion 18, as long as they are spaced and positioned to perform the functions described herein, without departing from this disclosure.

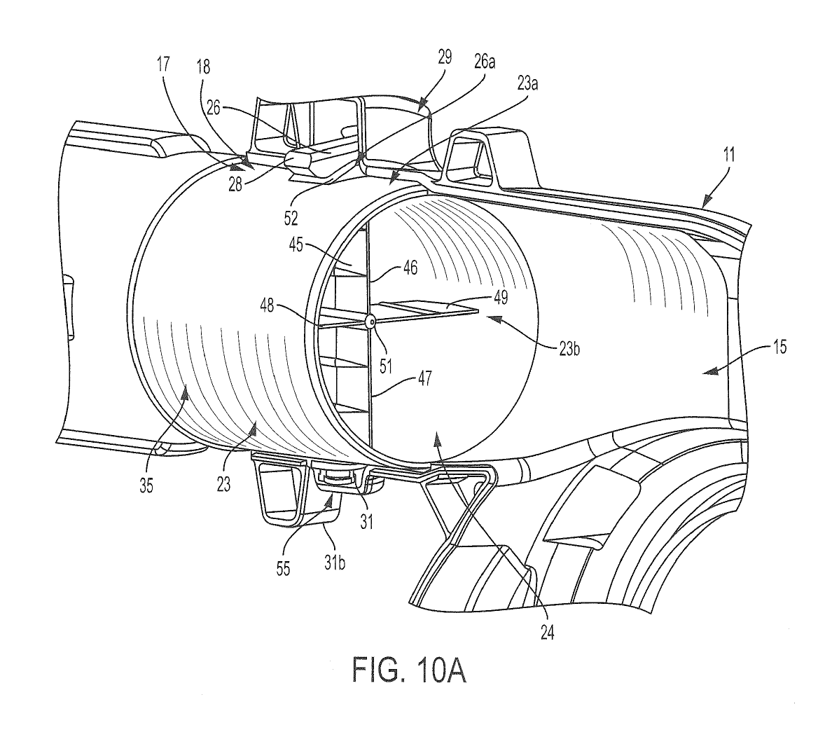

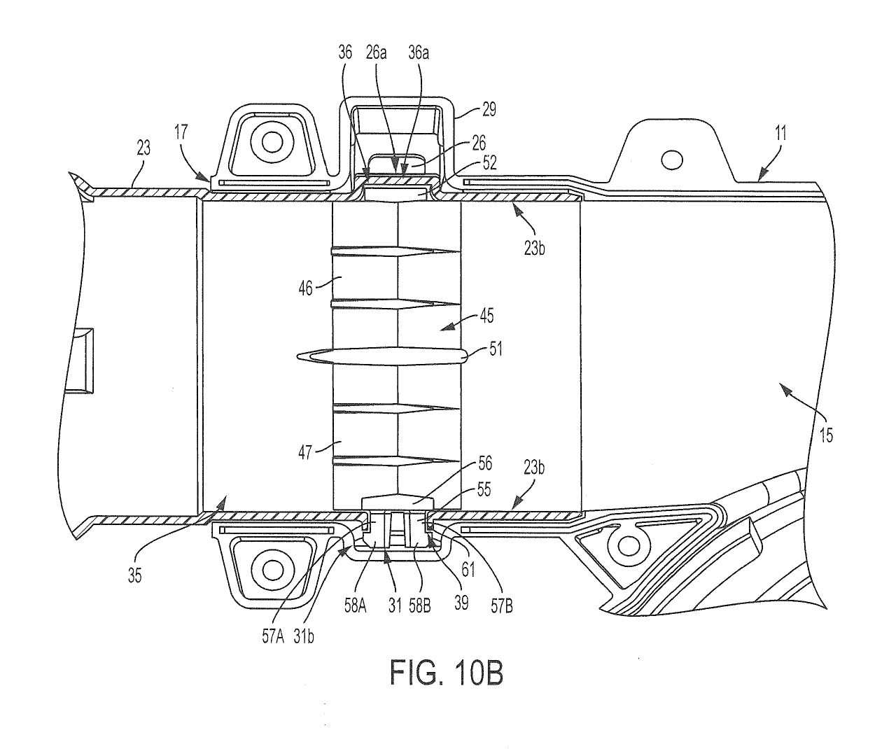

In the illustrated embodiment, the blower tube 23 can be formed as a separate part from the housing 11, and typically made of molded plastic. Tube 23 can have a first end 35 that is tapered and sized to fit snugly into the housing 11 at the air outlet aperture 17 of the distal end portion 18, and the tube 23 also can have a second end 41 opposite the tapered end 35 where air is discharged from the tube 23 (FIGS. 1A-C). A locking protrusion 36 may be arranged along an exterior surface 23a of the tube 23 at or near the first end 35, and the locking protrusion 36 can include a sloped side 37 and an upstanding, flat side 38 (FIG. 5). The locking protrusion 36 additionally may define or comprise a recess 36a arranged along an interior surface 23b of the blower tube 23. The blower tub 23 can include an aperture 39 arranged directly opposite from the locking protrusion 36 and recess 36a, which aperture 39 can extend through the wall of the tube 23 (FIGS. 4 and 10B). For example, the aperture 39 can be approximately 180 degrees from the locking protrusion 36, but could be otherwise located without departing from the disclosure. A blower tube locking collar 40 can extends around and define aperture 39, as shown in FIG. 4. The second end 41 of the blower tube 23 also can be tapered and have other attachment elements (not shown) that are formed integral with the blower tube 23. The second tapered end 41 facilitates the attachment of an additional blower tube or tube extension 43 to the blower tube 23 to, for example, further restrict the blower tube area and thus increase the velocity of air pushed from the blower tube (FIGS. 1A-C).

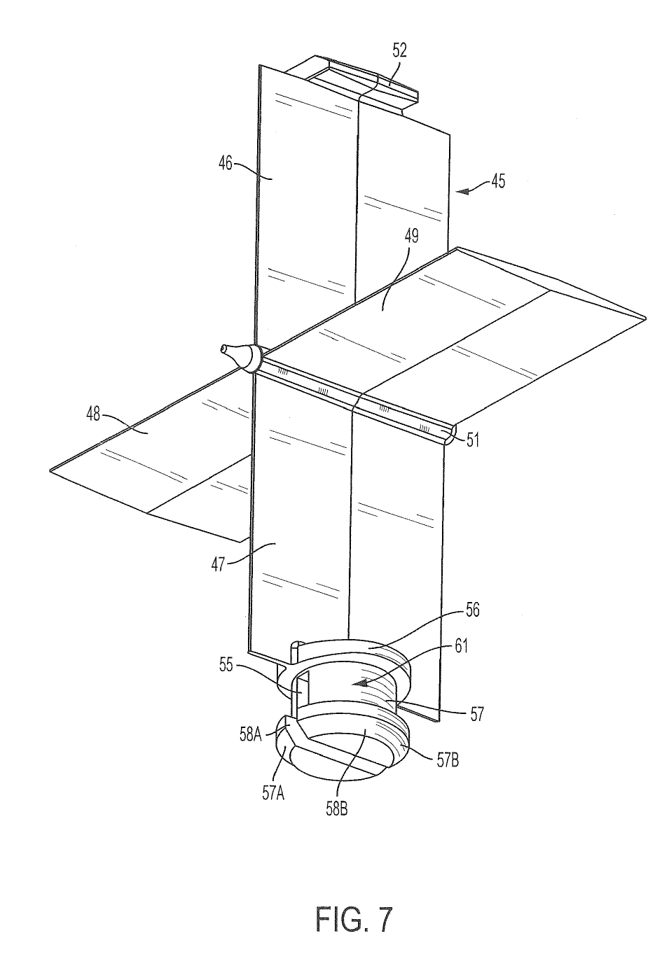

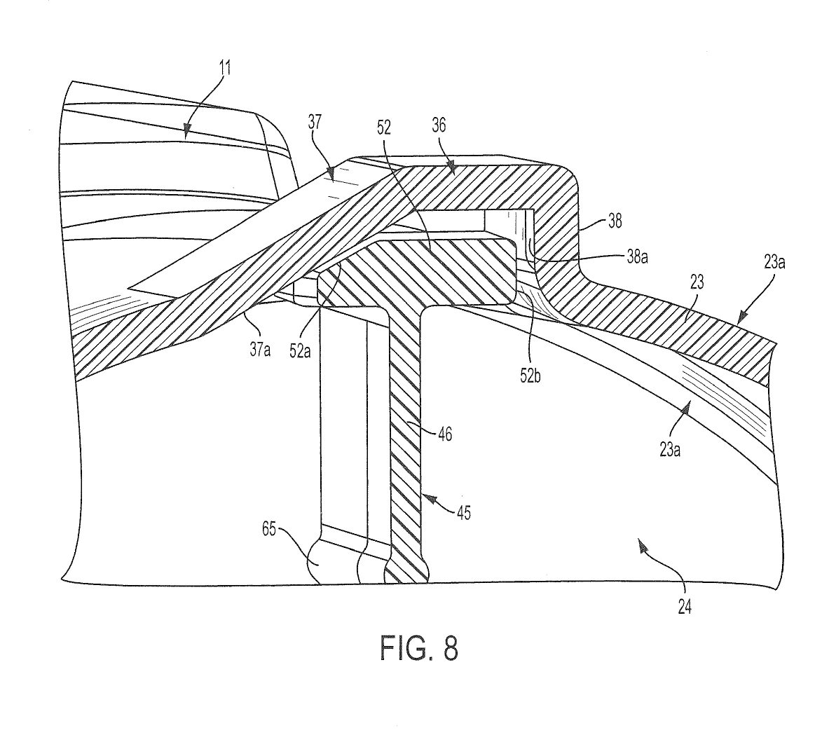

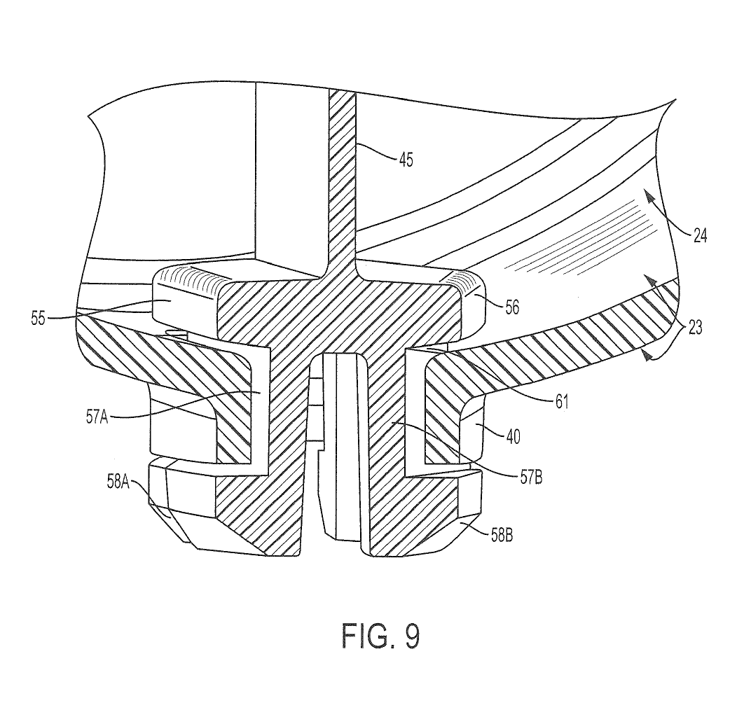

A guard 45 can fit within the blower tube 23 so as to he snugly attached within the tube 23. The guard 45 is shown in the illustrated embodiment as generally cross-shaped (FIG. 7), but may be of other shapes without departing from the disclosure. Guard 45 can include four arms 46, 47, 48 and 49, joined at a central hub 51; however, the guard may include any number of arms without departing from the disclosure. The distal end of arm 46 can includes an anti-pivot tab 52 sized and shaped to fit within the recess 36a of the locking protrusion 36 of the tube 23, as shown in FIGS. 7-8. The arm 47 can include a snap-in fitting 55 at the distal end of arm 47, and the fitting 55 can be generally cylindrical shaped and include an upper lock ring 56, as generally shown in FIG. 7. Extending away from the lock ring 56 may be a plurality of fitting legs, such two fitting legs 57A, 57B, that each terminate in a respective tab 58A, 58B, though two fitting legs 57A, 57B are shown in FIG. 7 any number of fitting legs, e.g., four fitting legs, can be used without departing from the disclosure. A recess 61 can be defined between the lock ring 56 and tabs 58A, 58B, respectively. The snap-in fitting 55 also may be made of plastic, allowing legs 57A, 57B to flex or bend. The flexibility of the legs 57A, 57B can allow the fitting 55 to be inserted into hole 39 up to lock ring 56 so that blower tube locking collar 40 is fitted in the recess 61 between lock ring 56 and tabs 58A, 58B. In this position, the anti-pivot tab 52 may be fitted snugly within the recess 36a of the locking protrusion 36 of the tube 23.

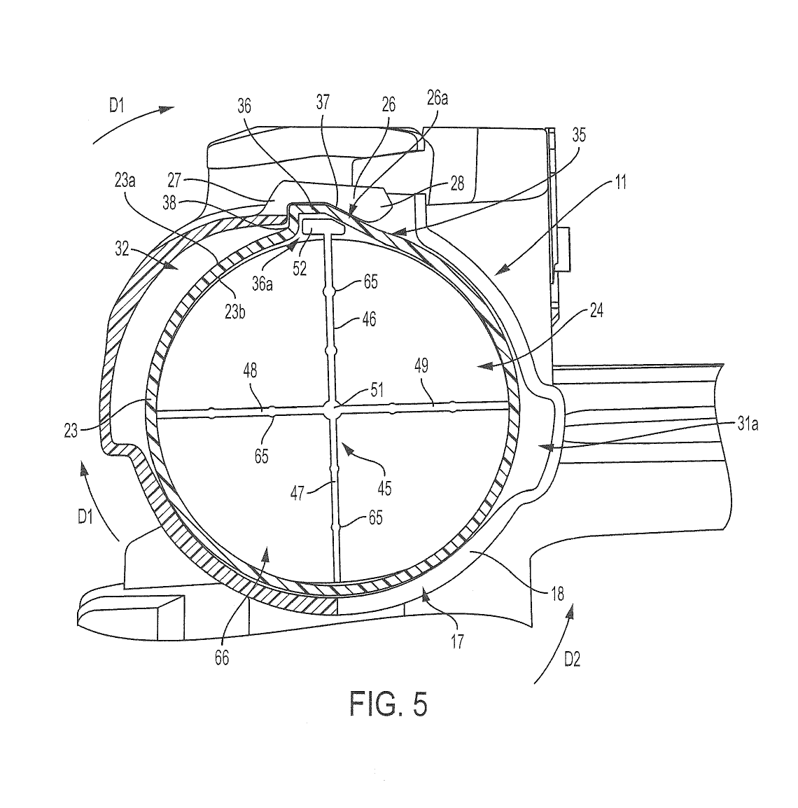

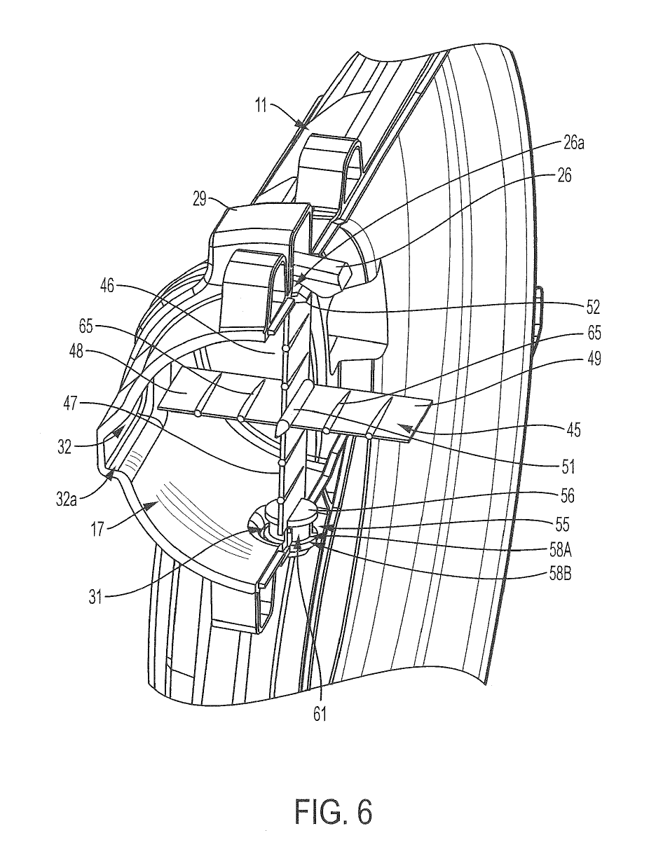

In one embodiment, the remaining two, opposing arms 48 and 49 of tube guard 45 may be identical, and extend away from hub 51 in opposite directions and located approximately 180 degrees from each other. The arms 48, 49 can be sited to extend from the hub 51 so that the ends 71, 73 of the arms 48, 49 are at least partially in contact with the inner surface 23b of the tube 23 (FIG. 10A). Therefore, the guard 45 blocks objects larger than the spaces or openings 5 (FIG. 4) between the adjacent arms 46, 47, 48, 49 and the inner surface 23b of the tube 23 from entering housing 11. The arms 46-49 of guard 45 can include a series of air guides or ribs 65, as generally shown in FIGS. 3-4 and 6, and the guards 45 may reduce turbulence or resistance of air flow past the guard 45, as well as assist with air flow through the blower tube 23 passing over legs 46-49.

To attach or connect the guard 45 within the blower tube 23, the guard 45 may be inserted into the blower tube 23 and moved, for example, rotated, until the anti-pivot tab 52 is received within the recess 36a arranged/defined along the interior surface 23a of the blower tube 23, and then the fitting legs 57A, 57B can be inserted through the aperture 39 such that the locking collar 40 of the blower tube 23 is fitted or secured in recess 61 between the locking ring 56 of the guard 45 and the tabs 58A, 58B (FIGS. 10A-B). With the fitting 57 inserted into opening 39, the tabs 58A,58B may extend or project outwardly from the exterior surface 23a of the blower tube 23. At least a portion of the tab 52, such as surfaces 52a or 52b, may engage or contact interior surfaces 37a or 38a (FIG. 8), respectively, arranged along/within recess 36a so as to prevent pivoting or rotation of the guard 45 with respect to the blower tube 23.

Once the guard 45 is attached within the blower tube 23 as described above (FIGS. 10A-B), the blower tube assembly 66, which includes the blower tube 23 and the guard 45, can be joined to and releasably attached to housing 11. To join the blower tube assembly 66 to the housing 11, the first tapered or bayonet end 35 can be slid into the air outlet aperture 17 of housing 11. To make this insertion, the locking protrusion 36 of the tube 23 may be aligned with an opening 32a of the anti-pivot tab channel or slot 32, and the tabs 58A, 58B of fitting 35 of the guard 45, which extend beyond the side wall of blower tube 23, also may be aligned with an opening 31a of the volute guide channel or slot 31 (FIGS. 4-5). With the locking protrusion 36 aligned with opening 32a and the tabs 58A, 58B aligned with opening 31a, the tapered end 35 of the blower tube 23 can be slid into outlet aperture 17 so that the locking protrusion 36 is inserted into opening 31a and moved or slid along channel 31 and the tabs 58A, 58B are inserted into opening 32a and moved or slid along channel 32.

Then, the blower tube 23 can be rotated, for example, the blower tube 23 can be rotated in a clockwise direction, e.g., direction D1 (FIGS. 4-5), so that the tabs 58A, 58B of fitting 57 move or slide further along guide slot 31. The housing 11 and blower tube 23 may also be configured such that the blower tube 23 is rotated in a counter-clockwise direction. The blower tube 23 can be rotated until reaching a stop position arranged along a bottom portion, or 6 o'clock position, of the outlet aperture 17 of the housing 11. Simultaneously, the locking protrusion 36 can be received into a recess 26a defined by the volute lock tab 26 of the housing 11 by slightly pushing the lock tab 26 upwardly as blower tube 23 is rotated, until the locking protrusion 36 is fully positioned within the recess 26a of the lock tab 26. At this position, lock tab 26 snaps back downwardly under its own spring action, locking the locking protrusion 36 in place. Also, in this position, removal and rotation of the blower tube 23 is restricted due to contact between the lock tab 26 and the locking protrusion 36 (FIG. 5). The tabs 58A, 58B positioned within guide slot 31 additionally may contact or engage an interior surface 31b of the guide slot 31 such that removal of the blower tube 23 from the housing 11 is further restricted. With this configuration, the guard 45 may perform the dual function of blocking objects larger than the openings 5 defined between arms 46-49 and the inner surface 23b of the tube 23 from entering the inner volute channel 15, and locking the blower tube 23 to the housing 11.

To remove the blower tube 23 from housing 11, the lock tab 26 can be manually lifted, freeing the blower tube locking protrusion 36 and allowing the blower tube 23 to be rotated counterclockwise, e.g. direction D2 shown in FIGS. 4-5, so that locking protrusion 36 slides within anti-pivot tab slot 32 and tabs 58A and 58B slide within volute guide slot 31 to disengage the locking features of the blower tube assembly 66 and allow the blower tube 23 to be removed from the housing 11.

In one embodiment, the guard 45 has guard features for preventing access to the distal end portion 18 of the volute channel 15 of the housing 11 in the faun of the arms 46-49 that are positioned and configured to size the openings 5 between the arms and the inner surface 23b of the tube 23 such that the size of the openings 5 restricts objects larger than the size of the openings from entering the housing. The guard 45 also has attachment features in the form of the fitting 55 that attaches the guard to the tube 23. The fitting 55 of the guard is configured to be inserted though the aperture 39 in the tube 23 to attach the guard 45 to the tube 23. Also, the tube 23 has attachment features in the form of locking protrusion 36 that is inserted in channel 32 in the housing 11 and positioned to attach the tube to the housing. The fitting 55 extends through the tube 23 and the guard 45 is inserted into the slot 31 and positioned to further attach the tube to the housing. The guard 45 and/or tube 23 could have other features and/or be otherwise configured without departing from the disclosure.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A blower comprising:
a housing defining an inlet, an outlet, and a volute channel in fluid communication with the inlet and the outlet;
a fan assembly at least partially supported by the housing, and including a fan;
a driving mechanism coupled to the fan assembly for rotating the fan to create air flow through the housing;
a tube removably connected to the housing and in fluid communication with the outlet to direct air flow exiting the housing; and
a guard at least partially received within the tube, the guard has guard features preventing access to the housing and attachment features attaching the guard to the tube.

2. The blower of claim 1, wherein the attachment features comprise a fitting extending through the tube.

3. The blower of claim 2, wherein the tube comprises an aperture and the fitting extends through the aperture.

4. The blower of claim 2, wherein the housing has an outlet portion that receives a portion of the tube, the outlet portion has a channel adjacent the tube and the fitting is received in the channel to attach the tube to the housing.

5. The blower of claim 3, wherein the fitting comprises a lock ring and at least two fitting legs extending from the lock ring, and the fitting is flexible to allow the at least two fitting legs to flex upon insertion through the aperture.

6. The blower of claim 5, wherein the fitting comprises a tab at a respective end of each of the at least two fitting legs and a recess between the lock ring and each respective tab.

7. The blower of claim 6, wherein the tube comprises a locking collar adjacent the aperture, the locking collar is attached to the fitting in the recess to attach the guard to the tube.

8. The blower of claim 3, wherein the guard comprises a plurality of arms extending from a hub, the fitting is at a distal end of one of the plurality of arms.

9. The blower of claim 8, wherein the one of the plurality of arms is a first arm, the plurality of arms comprises a second arm, the second arm comprises a tab at a distal end of the second arm.

10. The blower of claim 9, wherein the tube comprises a locking protrusion, the locking protrusion having a recess in an interior surface of the tube, the tab engages the recess.

11. The blower of claim 10, wherein the outlet portion comprises a locking tab adjacent the tube, the locking protrusion is received in the locking tab to attach the tube to the housing.

12. The blower of claim 10, wherein the second arm is positioned 180 degrees from the first arm.

13. The blower of claim 9, wherein the plurality of arms comprises a third arm and a fourth arm, the third and fourth arms have respective distal ends that are in contact with an interior surface of the tube.

14. The blower of claim 13, wherein the third arm is positioned 180 degrees from the fourth arm.

15. The blower of claim 8, wherein each arm of the plurality of arm comprises air guides on the surface of a respective arm to facilitate air flow in the tube.

16. The blower of claim 8, where guard features of the guard comprise the plurality of arms that are arranged to create respective openings between adjacent arms and the inner surface of the tube, the guard prevents objects larger than the openings from entering the housing.

17. A tube assembly for connection to a blower, the tube assembly comprising:
a tube for removable connection to a housing of the blower for directing air flow exiting the housing;
a guard at least partially received within the tube, the guard has guard features for preventing access to the housing and attachment features for attaching the guard to the tube.

18. The tube assembly of claim 18, wherein the tube comprises an aperture and the attachment features comprise a fitting extending through the aperture.

19. The tube assembly of claim 18, wherein the fitting comprises a lock ring and at least two fitting legs extending from the lock ring, and the fitting is flexible to allow the at least two fitting legs to flex upon insertion through the aperture.

20. The tube assembly of claim 19, wherein the tube comprises a locking collar adjacent the aperture, the fitting comprises a tab at a respective end of each of the at least two fitting legs and a recess between the lock ring and each tab, the locking collar is attached to the fitting in the recess to attach the guard to the tube.

21. The tube assembly of claim 19, wherein the guard comprises a plurality of arms extending from a hub, the fitting is at a distal end of one of the plurality of arms.

22. The tube assembly of claim 21, wherein the one of the plurality of arms is a first arm, the plurality of arms comprises a second arm, the second arm comprises a tab at a distal end of the second arm.

23. The tube assembly of claim 22, wherein the tube comprises a locking protrusion, the locking protrusion having a in an interior surface of the tube, the tab engages the recess.

24. The tube assembly of claim 22, wherein the plurality of arms comprises a third arm and a fourth arm, the third and fourth arms have respective distal ends that are in contact with an interior surface of the tube.

25. The tube assembly of claim 21, where guard features of the guard comprise the plurality of arms that are arranged to create respective openings between adjacent arms and the inner surface of the tube, the guard prevents objects larger than the openings from entering the housing.

26. A guard for use in a blower assembly comprising a housing and a tube for directing air flow exiting the housing, the guard has guard features for preventing access to the housing and attachment features for attaching the guard to the tube.

27. The guard of claim 25, comprising a plurality of arms extending from a hub, the fitting is at a distal end of one of the plurality of arms.

28. The guard of claim 25, wherein the one of the plurality of arms is a first arm, the plurality of arms comprises a second arm, the second arm comprises a tab at a distal end of the second arm, the tab configured for being received in a recess in an interior surface of the tube.

29. The guard of claim 28, wherein the second arm is positioned 180 degrees from the first arm, the plurality of arms comprises a third arm and a fourth arm, the third and fourth arms have respective distal ends that are in contact with an interior surface of the tube, the third arm is positioned 180 degrees from the fourth arm.

30. The guard of claim 28, where guard features of the guard comprise the plurality of arms that are arranged for creating respective openings between adjacent arms and the inner surface of the tube.

31. The guard of claim 26, wherein each arm of the plurality of arms comprises air guides on the surface of a respective arm shaped to facilitate air flow passed the guide.

32. The guard of claim 26, wherein the attachment features comprise a fitting at an end of at least one arm, the fitting being for extending through the tube, the fitting comprises a lock ring and at least two fitting legs extending from the lock ring, the fitting is flexible to allow the at least two fitting legs to flex.

33. The guard of claim 31, wherein the fitting comprises a tab at a respective end of each of the at least two fitting legs and a recess between the lock ring and each respective tab.

34. A method for assembling a blower, the method comprises:
obtaining a housing having an inlet, an outlet, and a volute channel in fluid communication with the inlet and outlet; a tube; and a guard, the guard has guard features and attachment features;
positioning the guard at least partially within the tube;
attaching the guard to the tube by inserting the attachment features through an aperture in the tube; and
attaching the tube to the housing.

35. The method of claim 34, wherein the attachment features comprise a fitting and the attaching the guard to the tube comprises inserting the fitting through the aperture.

36. The method of claim 34, wherein the attaching the tube to the housing comprises inserting a portion of the tube in an outlet portion of the housing, the outlet portion comprises a slot adjacent the outlet and the fitting is received in the slot when the portion of the tube is inserted into the outlet portion.

37. The method of claim 34, wherein the fitting comprises a lock ring, at least two fitting legs extending from the lock ring, a respective tab at a respective end of each of the at least two fitting legs, and a recess between the lock ring and each respective tab, the tube comprises a locking collar adjacent the aperture, the attaching the guard to the tube comprises locking the locking collar in the recess.

38. The method of claim 35, wherein the guard comprises a plurality of arms extending from a hub, the fitting is at a distal end of a first arm of the plurality of arms, the plurality of arms comprises a second arm, the second arm comprises a tab at a distal end, the tube comprises a locking protrusion having a recess in an interior surface of the tube, the attaching the guard to the tube comprises inserting the tab in the recess.

39. The method of claim 37, wherein the outlet portion comprises a locking tab, the attaching the tube to the housing comprises inserting the locking protrusion into the locking tab.
